(19) United States
(12) Patent Application Publication
(10) Pub. No.: US 2026/0351757 A1
(43) Pub. Date: Nov. 5, 2026

(54) BATTERY POTTING MATERIAL WITH IMPROVED ADHESION TO METAL

(71) Applicant: BASF SE, Ludwigshafen Am Rhein (DE)

(72) Inventors: Thomas MATHIEU, Lemfoerde (DE); Kristen M LIBERACKI, Wyandotte, MI (US); David Dean PETERS, Wyandotte, MI (US); Andreas WOLF, Lemfoerde (DE); Matthias BENDER, Lemfoerde (DE); Christian HAGEN, Lemfoerde (DE)

(73) Assignee: BASF SE, Ludwigshafen Am Rhein (DE)

(21) Appl. No.: 19/109,615

(22) PCT Filed: Sep. 7, 2023
(86) PCT No.: PCT/EP2023/074553

§ 371 Date: Mar. 7, 2025

Related U.S. Application Data
(60) Provisional application No. 63/375,071, filed on Sep. 9, 2022.

(30) Foreign Application Priority Data
Sep. 9, 2022 (EP) 22194738.5

(51) Int. Cl. H01M 50/242; H01M 50/293; H01M 50/383

(52) U.S. Cl. CPC H01M 50/242; H01M 50/293; H01M 50/383; H01M 2200/00

(57) ABSTRACT

The present invention relates to a battery module wherein the electric cells are potted into a potting material and the potting material is obtained by mixing (a) one or more organic polyiso-cyanates, (b) one or more polymeric compounds having at least two isocyanate-reactive hydrogen atoms, (c) 0.5 to 15 wt.-%, based on the total weight of components a) to f), of one or more chain extenders, comprising O—H-chain extenders (cl) and aromatic diamine curing agents (c2), (d) optionally one or more cross linkers, (e) one or more aromatic diamine curing agents, (f) one or more catalysts, (g) 2 to 20 wt.-% based on the total weight of components a) to g), of one or more flame retardants, (h) at least one blowing agent and (i) optionally fillers and/or polyurethane additives, to give a reaction mixture and allow the reaction mixture to cure. The present invention is further directed to a method of producing a battery module wherein the electric cells are potted into a potting material and the potting material is obtained by inserting a reaction mixture according to the invention into the spaces between the adjacent electric cells of a battery case having the electric cells arranged within and allowing the reaction mixture to cure.

The present invention relates to a battery module wherein the electric cells are potted into a potting material and the potting material is obtained by mixing (a) one or more organic polyiso-cyanates, (b) one or more polymeric compounds having at least two isocyanate-reactive hydrogen atoms, (c) 0.5 to 15 wt.-%, based on the total weight of components a) to f), of one or more chain extenders, comprising O—H-chain extenders (c1) and aromatic diamine curing agents (c2), (d) optionally one or more cross linkers, (e) one or more catalysts, (f) 2 to 20 wt.-% based on the total weight of components a) to f), of one or more flame retardants, (g) at least one blowing agent and (h) optionally fillers and/or polyurethane additives, to give a reaction mixture and allow the reaction mixture to cure. The present invention is further directed to a method of producing a battery module wherein the electric cells are potted into a potting material and the potting material is obtained by inserting a reaction mixture according to the invention into the spaces between the adjacent electric cells of a battery case having the electric cells arranged within and allowing the reaction mixture to cure.

There is a very fast transition in the automotive industry to go from combustion engines to elec-trified vehicles. The design of the batteries can be very different and is usually based on three types of battery cells: prismatic, pouch or cylindrical cells. Especially for the cell-to-pack design of cylindrical cells but not limited to that there are foams described in the literature that fill the cavities between the cells. The main goals of the foam are thermal insulation to prevent a chain reaction in the case of a thermal runaway and fixation of the cells. In addition, it is the task of the foam to stabilize the battery mechanically by stiffening the battery and minimizing vibrations.

A potting foam based on polyurethane is for example disclosed in US2012/0003508. This doc-ument discloses an energy storage device containing a foam which can be a polyurethane foam containing phosphates as flame-retardants [0043]. The foam is described as electrically isolating and showing a thermal conductivity between 0.02 W/mK and 1.0 W/mK. The function of the foam is to combat the propagation of fire to the other generators of the battery by covering the side wall of the container of each generator with this foam. US2012/0003508 does not provide further details on the foam or its mechanical properties.

EP 3753056 discloses a battery module comprising a polyurethane-based potting compound that reacts to a foam with a density below 0.5 g/cm³ and which contains liquid flame retardants and additives such as chain extenders. The electric cells embedded into the foam are described as cylinders. After being fully cured, the potting compound may have a certain degree of elastic-ity, thereby buffering shock or vibrations imparted to the battery module. The encapsulation of the battery cells ensures a suitable level of protection, such as a suitable amount of structural stability and/or a suitable amount of flame retardant to help to reduce the likelihood of an uncon-trolled fire from the battery module.

WO2020/044744 addresses the problem of shrinkage of a foam comprising flame retardant. This shrinkage leads to deformation of the battery and gap formation at the cells. This gap formation reduces the fire spread prevention properties. To prevent shrinkage WO2020/044744 teaches to apply 20 to 150 parts by weight of the polyol, based on 100 parts by mass of the flame retardant and by applying 25 to 75% by weight of a flame retardant, based on the total mass of the potting material. The polyol comprises 70 to 100 parts by weight of a polyol having a molecular weight of 2000 or more and preferably a polyol having a molecular weight of 200 or less.

CN109053993 discloses a protective material for a power battery with water as blowing agent. In Example 1 a 100:20 mixing ratio is used to mix a polyol component comprising polyol, catalyst, water and butanediol with an isocyanate component comprising MDI. CN 109053993 does not disclose the addition of flme retardant.

CN109251303 discloses a flame-retardant heat-insulating material for a power battery based on water blown polyurethane. Polyol and polyisocyanate component are mixed in a mixing ratio of 100:20 to 100:60.

CN111607351 discloses a potting material for battery modules comprising organic polyisocyanates, polyether polyol, chain extender, flame retardant and catalyst. CN111607351 does not disclose the addition of a blowing agent and therefore does not disclose a polyurethane.

The known show very weak adhesion properties on metal, especially on steel. Often the housing of battery cells is made of Hilumin® substrates. Hilumin® is an electro nickel-plated diffusion annealed steel. Therefore, a Hilumin® surface is often the surface a battery potting foam must adhere to. The problem to be solved is to increase the adhesion of a polyurethane foam to such kind of surfaces to ensure a better fixation of the foam to the cells and to prevent gap formation. This increases safety and lifetime of the whole battery.

It was the object of the present invention to improve the adhesion of polyurethane foam to metal surfaces, especially to steel or Hilumin®-surfaces, and thus increasing lifetime and security of the whole battery. It was further object of the present invention to reduce the amount of flame retardant in a potting material while maintaining fire spread prevention properties and to provide a foam with excellent properties in adhesion to the cells, vibration damping and shock adsorp-tion.

The object of the present invention has been solved by a a battery module wherein the electric cells are potted into a potting material and the potting material is obtained by mixing (a) one or more organic polyisocyanates, (b) one or more polymeric compounds having at least two isocy-anate-reactive hydrogen atoms, (c) 0.5 to 15 wt.-%, based on the total weight of components a) to f), of one or more chain extenders, comprising O—H-chain extenders (c1) and aromatic diamine curing agents (c2), (d) optionally one or more cross linkers, (e) one or more catalysts, (f) 2 to 20 wt.-% based on the total weight of components a) to f), of one or more flame retardants, (g) at least one blowing agent and (h) optionally fillers and/or polyurethane additives, to give a reaction mixture and allowing the reaction mixture to cure. The present invention is further directed to a method of producing a battery module wherein the electric cells are potted into a potting material and the potting material is obtained by inserting a reaction mixture according to the invention into the spaces between the adjacent electric cells of a battery case having the electric cells arranged within and allowing the reaction mixture to cure.

A Battery module, according to the present invention, comprises several electric cells. In a preferred method the cells are of cylindric shape. In a preferred embodiment the outer surface of the cells is a metal, preferably steel and especially preferred Hilumin®-steel. Such battery modules can be applied for a series of mobile devices and are especially suited for electric vehicles such as electric cars. The cells of the battery module according to the present invention are positioned in a potting material and the potting material is a polyurethane foam. Such a polyurethane foam is obtained by a method according to the invention. The foam potting compound has preferably at least a V2 level flame resistance as measured by the UL 94 Test for Flammability of Plastics. The battery cells are preferably surrounded by a battery case. The battery case may be configured to provide protection from moisture, heat, cold, or any other potential factors that may cause damage to the electric cells. In a preferred embodiment the case comprises a bottom part, a top part and a wall, extending between the bottom and the top. The bottom may be a positive terminal or may be a negative terminal of the electric cell, depending on the desired orientation. The bottom of the electric cell is positioned in the potting compound. The potting compound occupies a portion of the internal volume of the battery case and extends a substantially equal distance at various points along the wall from the bottom of the battery case toward the top. Typically, the top of the potting compound is lower than the top of the electric cells. Alternatively, the top of the electric cells may be lower than the top of the potting compound. The battery module may be used to power any number of applications, such as but not limited to a household appliance, outdoor electrical equipment, or a vehicle such as a car or a boat.

The size of the gap between adjacent electric cells and/or the battery case can be selected based on several variables, including but not limited to the size and/or weight of each electric cell, the operating temperature of each electric cell, the dimensions of each electric cell and the intended use of the battery module. In some examples, the size of the space between adjacent electric cells may be from greater than 0 mm, about 0.25 mm, about 0.50 mm, about 0.75 mm, to about 1.0 mm, about 1.5 mm, or about 2.0 mm, or a length between any pair of the foregoing values.

The hardness of the urethane foam as a potting material for the battery module is preferably from 40 shoreA to 60 shoreD. As a result, damage to the battery caused by stress at the time of resin curing can be reduced, and an external shock to which the battery pack receives can be appropriately absorbed. In addition, the potting material gives structural stiffness and stability to the whole battery module.

The potting material is obtained by mixing (a) one or more organic polyisocyanates, (b) one or more polymeric compounds having at least two isocyanate-reactive hydrogen atoms, (c) 0.5 to 15 wt.-%, based on the total weight of components a) to f), of one or more chain extenders, comprising O—H-chain extenders (c1) and aromatic diamine curing agents (c2), (d) optionally one or more cross linkers, (e) one or more catalysts, (f) 2 to 20 wt.-% based on the total weight of components a) to f), of one or more flame retardants, (g) at least one blowing agent and (h) optionally fillers and/or polyurethane additives, to give a reaction mixture and allow the reaction mixture to cure. The reaction mixture can flow through the gap between adjacent electric cells and settle at a level height around the electric cells and in the gap or spaces defined between the electric cells. For example, the reaction mixture may be poured into the battery case having the electric cells arranged within. The liquid reaction mixture has sufficient flowability before curing to permit the liquid potting composition to flow through the spaces defined by the gap between the adjacent electric cells and/or between an electric cell and the battery case and to settle at a substantially level height before its viscosity increases significantly due to the hardening process.

In a preferred embodiment the potting material according to the invention has a density of 20 to 800 g/dm³, more preferred 50 to 600 g/dm³ even more preferred 100 to 500 g/dm³ and especially preferred 100 to 300 g/dm³.

According to the present invention, the polyisocyanate components (a) used for the production of the polyurethanes of the invention comprise any of the polyisocyanates known for the production of polyurethanes. These comprise the aliphatic, cycloaliphatic, and aromatic difunctional or polyfunctional isocyanates known from the prior art, and also any desired mixtures thereof. Examples are diphenylmethane 2,2′-, 2,4′-, and 4,4′-diisocyanate, the mixtures of monomeric di-phenylmethane diisocyanates with diphenylmethane diisocyanate homologs having a larger number of rings (polymer MDI), isophorone diisocyanate (IPDI) and its oligomers, tolylene 2,4- and 2,6-diisocyanate (TDI), and mixtures of these, tetramethylene diisocyanate and its oligomers, hexamethylene diisocyanate (HDI) and its oligomers, naphthylene diisocyanate (NDI), and mixtures thereof.

It is preferably to use tolylene 2,4- and/or 2,6-diisocynate (TDI) or a mixture thereof, monomeric diphenylmethane diisocyanates, and/or diphenylmethane diisocyanate homologs (polymer MDI), and mixtures of these. Other possible isocyanates are mentioned by way of example in “Polyurethanes Handbook”, Carl Hanser Verlag, 2^{nd} edition 1994, chapter 3.2 and 3.3.2.

In an especially preferred embodiment, the polyisocyanates (a) comprise at least one Isocyanate selected from the group consisting of monomeric MDI, polymeric MDI, MDI based prepolymers or mixtures of at least two of these. At least 80%, preferably at least 90%, and more preferred 100% by weight of the isocyanates (a) consist of monomeric MDI, polymeric MDI, MDI based prepolymers or mixtures of at least two of these.

Polyisocyanate component (a) used can be used in form of polyisocyanate prepolymers. These polyisocyanates prepolymers are obtainable by reacting the polyisocyanates described above (constituent (a-1)) in excess, for example at temperatures of from 30 to 100 °C, preferably at about 80 °C, with polymeric compounds (b) (constituent (a-2)), having groups reactive toward isocyanates, and/or with chain extenders (c) (constituent (a-3)) to give the isocyanate prepoly-mer.

Polymeric compounds (a-2) having groups reactive toward isocyanates are known to the person skilled in the art and are described by way of example in “Polyurethanes Handbook”, Carl Hanser Verlag, 2nd edition 1994, chapter 3.1: by way of example, it is also possible to use, as polymeric compounds (a-2) having groups reactive toward isocyanates, the polymeric compounds described under (b) having groups reactive toward isocyanates.

In a preferred embodiment content of monomeric MDI and polymeric MDI in component (a), is at least 35 wt.-%, more preferred 40 to 70 wt.-% more preferred 41 bis 60 wt.-% and especially preferred 42 to 48% by weight, based on the total weight of components (a) to (f). According to the present invention the amount of monomeric MDI and polymeric MDI in component (a) in-cludes monomeric and polymeric MDI (a-1) which was used for the production of polyisocyanate prepolymers, regardless of whether it is present as an individual molecule or as a reaction product with polymeric compounds (a-2).

It is possible to use, as polymeric compounds (b) having groups reactive toward isocyanates, any of the known compounds having at least two hydrogen atoms reactive toward isocyanates, for example those with functionality from 2 to 8 and with number-average molar mass from 400 to 15 000 g/mol: by way of example it is possible to use compounds selected from the group of the polyether polyols, fatty acid based polyols, polybutadiene based polyols, polyester polyols, and mixtures thereof.

Polyetherols are by way of example produced from epoxides; for example, propylene oxide and/or ethylene oxide, or from tetrahydrofuran with starter compounds exhibiting hydrogen-activity containing 1 to 8, preferably 2 to 6 reactive hydrogen atoms bound, or a starter molecule mixture which contains 1.5 to 8, preferably 2 to 6 reactive hydrogen atoms bound in the presence of catalysts. As starter molecules for example aliphatic alcohols, phenols, amines, carboxylic acids, water, or compounds based on natural substances, for example sucrose, sorbitol or mannitol can be applied. If mixtures of starter molecules with different functionalities are used, fractional functionalities can be obtained. Influences on the functionality, for example through side reactions, are not considered in the nominal functionality. Examples for suitable catalysts are basic catalysts and double-metal cyanide catalysts, as described by way of example in PCT/EP2005/010124, EP 90444, or WO 05/090440.

Polyesterols are by way of example produced from aliphatic or aromatic dicarboxylic acids and polyhydric alcohols, polythioether polyols, polyesteramides, hydroxylated polyacetals, and/or hydroxylated aliphatic polycarbonates, preferably in the presence of an esterification catalyst. Other possible polyols are mentioned by way of example in “Polyurethanes Handbook], volume 7, Polyurethane [Polyurethanes]”, Carl Hanser Verlag, 2^{nd} edition 1993, chapter 3.1.

Other materials that can be used, alongside the polyetherols and/or polyesterols described, are filled polyols as polymer polyols like polymer polyetherols or polymer polyesterols. These compounds preferably comprise dispersed particles made of thermoplastics, for example composed of olefinic monomers such as acrylonitrile, styrene, (meth)acrylates, (meth)acrylic acid, and/or acrylamide. These polyols comprising fillers are known and are obtainable commercially. A production process for these is described by way of example in DE 111 394, U.S. Pat. Nos. 3,304,273, 3,383,351, 3,523,093, DE 1 152 536, DE 1 152 537 WO 2008/055952, and WO 2009/128279.

In a particularly preferred embodiment of the present invention, component (b) comprises polyetherols, and more preferably comprises no polyesterols.

It is preferred that polymeric compounds (b) having groups reactive toward isocyanates comprise at least one polyetherol (b1) having a functionality of 2 to 4 and a hydroxyl value of 20 to 60 mg KOH/g. Polyethersols (b1) comprise preferably more than 50%, more preferred more than 70%, even more preferred more than 80%, and especially preferred more than 90% primary hydroxyl groups based on the total number of hydroxly groups in the polyether (b1).

If polymer polyols are used polymer polyols are applied in an amount of preferably 1 to 30 wt.-%, more preferred 2 to 20 wt.-%, even more preferred 3 to 15 wt.-% and most preferred 4 to 10 wt.-%, each based on the total weight of component (a) to (f).

Chain extenders (c) used here can be compounds of molar mass less than 400 g/mol, preferably less than 300 g/mol and more preferred 62 to 250 g/mol, which have two groups reactive toward isocyanates as for example OH—, SH or NH₂-groups. According to the present invention chain extenders are used in an amount of 0.5 to 15 wt.-%, preferably 2-15 more preferred 3 to 15 wt.-%, and especially preferred 5 to 12 wt.-%, each based on the total weight of components a) to (f).

As chain extenders (c), use may be made of the chain extenders known in the production of polyurethanes. Chain extenders (c) comprise compounds having two OH groups (c1) (hereinafter OH-Chain extenders) and aromatic diamines (c2) (hereinafter aromatic diamine curing agents) In a preferred embodiment OH-chain extenders (c1) may be selected from the group consisting of monoethylene glycol, diethylene glycol, 1,2-propane diol, 1,3 propane diol, 1,4 butane diol, 1,3 butane diol, 1,5 pentane diol, 1,6-hexane diol, neopentyl glycol, tetraethylene glycol, dipropylene glycol cyclohexane dio or mixtures thereof. In a more preferred embodiment the OH-chain extender is selected from the group, consisting of monoethylene glycol, diethylene glycol, dipropylene glycol, 1,2-propane diol, 1,3 propane diol, 1,4 butane diol, 1,6 hexane diol or mixtures thereof. Other possible low-molecular-weight chain extenders are mentioned by way of example in “Polyurethane Handbook”, Carl Hanser Verlag, 2^{nd} edition 1994, chapter 3.2 and 3.3.2.

Aromatic diamine curing agents (c2), are selected from the group aromatic amine based chain extenders as aromatic diamines like diethyl toluene diamine (DETDA). In a preferred embodiment exclusively OH-chain extenders (c1) and aromatic diamine curing agents (c2), are used as chain extenders (c). A preferred example of an aromatic diamine curing agent is DETDA. If used, the aromatic diamine curing agent (c2) is applied in an amount of preferably 0.5 to 4% by weight, preferably 1 to 3% by weight, each based on the total weight of compounds (a) to (f) with the provision that the total amount of chain extenders (c), does not exceed 15% by weight, preferably 12% by weight, each based on the total weight of compounds (a) to (f). In a preferred embodiment the ratio of the OH-chain extender (c1) and the aromatic diamine curing agent (c2) is between 200 to 1 and 1 to 1, preferably 100 to 1 and 2 to 1 and especially preferred 50 to 1 and 3 to 1.

In addition to chain extenders (c) crosslinking agents (d) may be added to the mixture. As chain extenders, crosslinking agents used in the invention are compounds of molar mass less than 400 g/mol preferably less than 300 g/mol and more preferred 60 to 250 g/mol which have at least three groups reactive toward isocyanates. Examples for crosslinking agents are glycerine, trimethylolpropane, pentaerythritol and triethanolamine. Other possible low-molecular-weight crosslinking agents are mentioned by way of example in “Polyurethane Handbook”, Carl Hanser Verlag, 2^{nd} edition 1994, chapter 3.2 and 3.3.2.

In a preferred embodiment of the present invention in addition to the at least one chain extender (c) at least one crosslinking agent (d) is added to the mixture of the present invention. In a preferred embodiment the mixture comprises 1 to 8% by weight, more preferred 2 to 5% by weight of at least one crosslinking agent, based on the total weight of components a) to (f).

Catalysts (e) greatly accelerate the reaction of the polyols (b) and optionally chain extenders (c) and crosslinking agent (d), and also chemical blowing agent (e) with the polyisocyanates (a). As catalysts (e) any catalyst known in the field of polyurethane catalysts may be used. These comprise basic amine catalysts and metal-based catalysts. In a preferred embodiment the catalysts comprise incorporable amine catalysts. In a further preferred embodiment the catalysts comprise delayed action catalysts. Delayed action catalysts are well known in the art and provide a long open time of the reaction mixture at room temperature and a fast curing at elevated temperatures.

Incorporable amine catalysts have at least one, preferably from 1 to 8, and particularly preferably from 1 to 2, groups reactive toward isocyanates, for example primary amine groups, secondary amine groups, hydroxy groups, amides, or urea groups, preferably primary amine groups, secondary amine groups, or hydroxy groups. Incorporable amine catalysts are used mostly for the production of low-emission polyurethanes which are in particular used in the au-tomobile-interior sector. These catalysts are known and are described by way of example in EP1888664. These comprise compounds which preferably comprise, alongside the group(s) reactive toward isocyanates, one or more tertiary amino groups. It is preferable that at least one tertiary amino groups of the incorporable catalysts bear at least two aliphatic hydrocarbon moieties, preferably having from 1 to 10 carbon atoms per moiety, particularly preferably having from 1 to 6 carbon atoms per moiety. It is particularly preferable that the tertiary amino groups bear two moieties selected mutually independently from methyl and ethyl moiety, and bear another organic moiety. Examples of incorporable catalysts that can be used are bisdimethyla-minopropylurea, bis(N,N-dimethylaminoethoxyethyl) carbamate, dimethylaminopropylurea, N,N, N-trimethyl-N-hydroxyethylbis(aminopropyl ether), N, N, N-trimethyl-N-hydroxyethylbis(aminoethyl ether), diethylethanolamine, bis(N, N-dimethyl-3-aminopropyl)amine, dimethylaminopropylamine, 3-dimethyaminopropyl-N, N-dimethylpropane-1,3-diamine, dimethyl-2-(2-aminoethoxyethanol), and (1,3-bis(dimethylamino) propan-2-ol), N,N-bis(3-dimethylaminopropyl)-N-isopropanolamine, bis(dimethylaminopropyl)-2-hydroxyethylamine, N,N,N-trimethyl-N-(3 aminopropyl)bis(aminoethyl ether), 3-dimethylaminoisopropyldiisopropanolamine, and mixtures thereof.

Examples for delayed action catalysts are carboxylic salt used of a conventional basic amine catalyst. The carboxylic salts of the basic amine catalysts for example are obtained here by mixing the amine catalysts with carboxylic acids, optionally in presence of an alcohol as ethylene glycol. If an alcohol which falls under the definition of a chain extender (c) or a crosslinker (d) the amount is considered when calculating the amount of crosslinker and chain extender in the reaction mixture.

Basic amine catalysts suitable for the production of delayed action catalysts are described by way of example in “Polyurethane Handbook”, Carl Hanser Verlag, 2nd edition 1994, chapter 3.4.1. Examples of these are amidines, such as 2,3-dimethyl-3,4,5,6-tetrahydropyrimidine, tertiary amines, such as triethylamine, tributylamine, dimethylbenzylamine, N-methyl-, N-ethyl-, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl) urea, N,N-bis(3-dimethylaminopropyl)-N-isopropanolamine, dimethylpiperazine, 1,2-dimethylimidazole, 1-azabicyclo[3.3.0]octane and preferably 1,4-diazabicyclo[2.2.2]octane and alkanolamine compounds, such as triethanolamine, triisopropanolamine, N-methyl- and N-ethyldiethanolamine N,N-bis(3-dimethylaminopropyl)-N-isopropanolamine, and dimethylethanolamine. Basic amine catalysts which have at least one, preferably precisely one, group reactive toward isocyanates are in particular used here, an example being N, N-bis(3-dimethylaminopropyl)-N-isopropanolamine. The catalysts can be used individually or in the form of mixtures.

Carboxylic acids used are preferably those whose molar mass is smaller than 300 g/mol. It is particularly preferable here to use saturated and unsaturated aliphatic monocarboxylic acids having from 1 to 18 carbon atoms, e.g. formic acid, acetic acid, cyanoacetic acid, or 2-ethylhexanoic acid, aromatic carboxylic acids, aliphatic, saturated and unsaturated dicarboxylic acids having from 2 to 16 carbon atoms, or tricarboxylic acids, or a mixture thereof. Derivatives of the abovementioned carboxylic acids can also be used. Other preferred carboxylic acids used are dicarboxylic acids of the general formula HOOC—(CH₂)ₙ—COOH, where n is a whole number from 2 to 14. Dicarboxylic acids of this type are generally less corrosive. In particular, the carboxylic acid used comprises adipic acid.

The ratio of acid and amine catalyst here is selected in such a way that the number of equivalents of acid groups of a carboxylic acid comprised is from 0.5 to 1.5, preferably from 0.7 to 1.3, particularly preferably from 0.90 to 1.10, and in particular from 0.95 to 1.05 equivalents, based on one equivalent of amine of the amine catalyst.

An example of a concentration that can be used of the carboxylic salts of an amine catalyst (c) is from 0.001 to 10% by weight, preferably from 0.05 to 5% by weight, and particularly preferably from 0.05 to 2% by weight, based on the weight of components (b) to (f).

Conventional, non-incorporable amine catalysts may comprise amidines, such as 2,3-dimethyl-3,4,5,6-tetrahydropyrimidine, tertiary amines, such as triethylamine, tributylamine, dimethylbenzylamine, N-methyl-, N-ethyl-, and N-cyclohexylmorpholine, N, N,N′, N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl) urea, dimethylpiperazine, 1,2-dimethylimidazole, 1-azabicyclo[3.3.0]octane, and preferably 1,4-diazabicyclo[2.2.2]octane, and alkanolamine compounds, such as triethanolamine, triisopropanolamine, N-methyl- and N-ethyldiethanolamine, and dimethylethanolamine.

Suitable metal based catalysts comprise organometallic compounds, preferably organotin compounds, such as tin (II) salts of organic carboxylic acids, e.g. tin (II) acetate, tin (II) octoate, tin (II) ethylhexoate, and tin (II) laurate, and the dialkyltin (IV) salts of organic carboxylic acids, e.g. dibutyltin diacetate, dibutyltin dilaurate, dibutyltin maleate, and dioctyltin diacetate, and also bismuth carboxylates, such as bismuth (III) neodecanoate, bismuth 2-ethylhexanoate, and bismuth oc-tanoate, or a mixture thereof. The organometallic compounds can be used alone or preferably in combination with strongly basic amines. In a particularly preferred embodiment, catalysts (e) used comprise or consist of delayed action catalysts and especially preferred incorporable delayed action catalysts.

If catalysts (e) are used, these can by way of example be used at a concentration of from 0.001 to 5% by weight, in particular from 0.05 to 2% by weight, as catalyst or, respectively, catalyst combination, based on the weight of component (b).

As flame retardants (f) generally all flame retardants known from the prior art can be used. Suitable flame retardants are, for example, bromate esters, brominated ethers or brominated alcohols such as dibromoneopentylakohol, tribromo-neopentyl alcohol and 2-(2-hydroxyethoxy)ethyl 2-hydroxypropyl 3,4,5,6-tetrabromophthalates (PHT-4-diol™), and chlorinated phosphates such as tris(2-chloroethyl)phosphate, tris(2-chloroisopropyl)phosphate (TCPP), tris(1,3-dichloropropyl)phosphate, tricresyl phosphate, 10 tris(2,3-dibromopropyl)phosphate, tetrakis (2-chloroethyl)-ethylene diphosphate, dimethylmethanephos phonate, diethanola-minomethylphosphonic acid diethyl ester, as well as commercially available halogenated flame retardant polyols. As further phosphates or phosphonates, diethylethane phosphonate (DEEP), Resorcinol bis(diphenyl phosphate (RDP), triethyl phosphate (TEP), dimethylpropyl phosphonate (DMPP), diphenylkresyl phosphate (DPK) can be used as liquid flame retardants. In a preferred embodiment the flame retardants comprise at least one group reactive towards isocyanates as a hydroxyl group (—OH) and/or a molecular weight of at least 350 g/mol.

In addition to the flame retardants already mentioned, inorganic or organic flame retardants such as red phosphorus, red phosphorus-containing additives, alumin dioxide hydrate, antimony trioxide, arsenic oxide, ammonium polyphosphate and calcium sulfate, or cyanuric acid derivatives, such as melamine, or mixtures of at least two of these flame retardants, such as ammonium polyphosphates and melamine, and optionally corn or ammonium polyphosphate, melamine, can be used as flame retardant (f) according to the present invention.

In a preferred embodiment of the present invention the flame retardants (f) comprise at least one flame retardant that are liquid at room temperature. Particularly preferred are RDP, TCPP, TEP, DEEP, DMPP, DPK, PHT4 diol™, brominated ether and tribromo-neopenthyl alcohol, especially TCPP, TEP and PHT4 diol™ and in particular TCPP as liquid flame retardant. In a particularly preferred embodiment, the flame retardant (c) comprises phosphorus-containing flame retardant and the content of phosphorus, based on the total weight of the components (a) to (f), is preferably 0.1 to 3% by weight, more preferred 0.1 to 1% by weight and especially preferred 0.1 to 0.5% by weight. In a preferred embodiment the flame retardant comprises a mixture of liquid flame retardants and solid flame retardants.

According to the invention, the proportion of the flame retardant (f) is 2 to 20% by weight, preferably 3 to 18 wt.-%, particularly preferably 4 to 16 wt.-%, and even more preferred 4 to 10 wt.-% and especially preferred 4 bis 8 wt.-%, based on the total weight of the components (a) to (f).

As blowing agent (g) any blowing agent known in the field of polyurethanes can be used. These can comprise chemical and/or physical blowing agents. These blowing agents are described by way of example in “Polyurethane Handbook”, Carl Hanser Verlag, 2nd edition 1994, chapter 3.4.5. The term chemical blowing agent here means compounds which form gaseous products through reaction with isocyanate. Examples of these blowing agents are water and carboxylic acids. The term physical blowing agents means compounds which have been dissolved or emulsified in the starting materials for the polyurethane production reaction and evaporate under the conditions of formation of polyurethane. These are by way of example hydrocarbons, halogenated hydrocarbons, halogenated hydroolefines and other compounds, examples being perfluorinated alkanes such as perfluorohexane, chlorofluorocarbons, and ethers, esters, ke-tones, acetals, and/or liquid carbon dioxide. Any desired quantity of the blowing agent can be used here. The quantity used of the blowing agent is preferably such that the density of the re-sultant polyurethane foam is from 10 to 850 g/L, particularly from 20 to 800 g/L, and in particular from 25 to 500 g/L. It is particularly preferable to use blowing agents comprising water, more preferred the blowing agents (g) is consisting of water.

It is moreover possible to use fillers and/or polyurethane additives (h). It is possible to use any of the fillers and additives known for the production of polyurethanes. Mention may be made by way of example of surface-active substances, foam stabilizers, cell regulators, release agents, inorganic and organic fillers, dyes, pigments, hydrolysis stabilizers, fungistatic substances, and bacteriostatic substances. These substances are known and are described by way of example in “Polyurethane Handbook”, Carl Hanser Verlag, 2nd edition 1994, chapter 3.4.4 and 3.4.6 to 3.4.11.

The quantities of the polyisocyanates (a), the one or more polymeric compounds having at least two isocyanate-reactive hydrogen atoms (b), the of one or more chain extenders (c), the one or more cross linkers (d), the one or more catalysts (e), the one or more flame retardants (f), the at least one blowing agent (g) and the fillers and/or polyurethane additives (h), if present, used in the production of the polyurethane of the invention are generally such that the equivalence ratio of NCO groups of the polyisocyanates (a) to the total number of the reactive hydrogen atoms of components (b) to (h) is preferably from 0.75 to 1.5:1, more preferably from 0.80 to 1.2:1, and especially preferred from 0.85 to 1.10. A ratio of 1:1 here corresponds to an isocyanate index of 100.

For the production of the battery module according to the present invention the reaction mixture according to the present invention can flow through the gap between adjacent electric cells and settle at a level height around the electric cells and in the gap or spaces defined between the electric cells. For example, the potting composition may be poured into the battery case having the electric cells arranged within. The liquid potting composition has sufficient flowability before curing to permit the liquid potting composition to flow through the spaces defined by the gap between the adjacent electric cells and/or between an electric cell and the battery case. The liquid reaction mixture has sufficient flowability to settle at a substantially level height before curing to form the potting material.

In a preferred embodiment the electric cells are cleaned before brought into contact with the reaction mixture according to the present invention, for example by plasma treatment.

The potting material according to the present invention shows a very good adhesion to metal as to steel surfaces and especially to Hilumin. This reduces unfavorable gap formation between the cells and the potting material improving flame retardancy, vibration damping and shock absorption. This allows the addition of smaller amounts of flame retardant while maintaining the flame retardant properties. The lower amount of flame retardant on the other hand improves the mechanical properties of the potting material. In addition, the electric cells are thermally insulat-ed from each other and the potting material, according to the present invention, offers high shock absorption properties and high vibration damping. In addition the potting material gives structural stiffness and stability to the whole battery module. Furthermore, the heat generated during the production of the foam according to the invention is low, so that the individual battery cells are protected from excessive heat stress in the manufacturing process.

The invention will be illustrated below with reference to examples.

### EXAMPLES

### Raw Materials:

Polyol 1: Polyetherol with a number average molecular weight of 2000 g/mol, a functionality of 2 and an OH #of 55 mgKOH/G

Polyol 2: Polyethertriol with a number average molecular weight of 700 g/mol, a functionality of 3 and based on glycerine and propylene oxide; OH #of 239 mgKOH/g

Polyol 3: Polyetherol based on TMP and propylene oxide with a functionality of 3 and an OH # of 860 mgKOH/g

Polyol 4: Polyetherol based on Ethylene diamine and propylene oxide with a functionality of 4 and an OH #of 753 mgKOH/g

Cross-linker 1: Glycerine, 99.7% purity

Cross-linker 2: Triethanolamie: 85% triethanolamine and 15% monoethanolamine

Additive 1: Aerosil® 200, fumed silica from Evonik

Additive 2: Zinc stearate, purchased from SigmaAldrich

Additive 3: Titandioxide, pigment, nucleating agent

Additive 4: Vorasurf® DC5160: Foam cell surfactant from Dow Chemicals

Additive 5:2,2,4-Trimethyl-1,3-pentanediol diisobutyrate

Catalyst 1: Lupragen N 201, Amine catalyst from BASF

Chain-extender 1: Monoethylene glycol

Chain-extender 2: Diethylene glycol

Chain-extender 3:1,4-butanediol

Chain-extender 4: Diethyltoluenediamine (EthaCure® 100 from Abermale)

Chain-extender 5: Dipropylene glycol

Flame-retardant (FR): Lupragen® TCPP: Tris(2-chloroisopropyl)phosphate; flame retardant from ICL;

Water: Tap water

Iso: Polyimeric MDI with an average functionality of 2.7 and an NCO-value of 31,5

According to the formulations as given in Tables 1 and 2, polyurethane foams were prepared, and their adhesion was tested according to the following test procedure:

### Determination of the Adhesion of Foam Systems to Steel Surfaces

Preparation of the test specimen:

### Materials Used:

Metal test specimen 25×100 mm with a thickness of 0.5-2 mm, cleaned with isopropanol
Foaming vessel with a diameter of 103 mm and a height of 10 mm
Support with a diameter of 103 mm and a height of 10 mm
Separating weight with the dimensions width×height×length 60×20×150 mm and a weight of 1300 g, wrapped with a Teflon foil.
Weight with the dimensions width×height×length 40×20×150 mm and a weight of 870 g
Spacer with the dimensions width×height×length 30×0.5×40 mm
Tractor Coesfeld

### Setup of the Bonding of Foam System and Metal Test Specimen

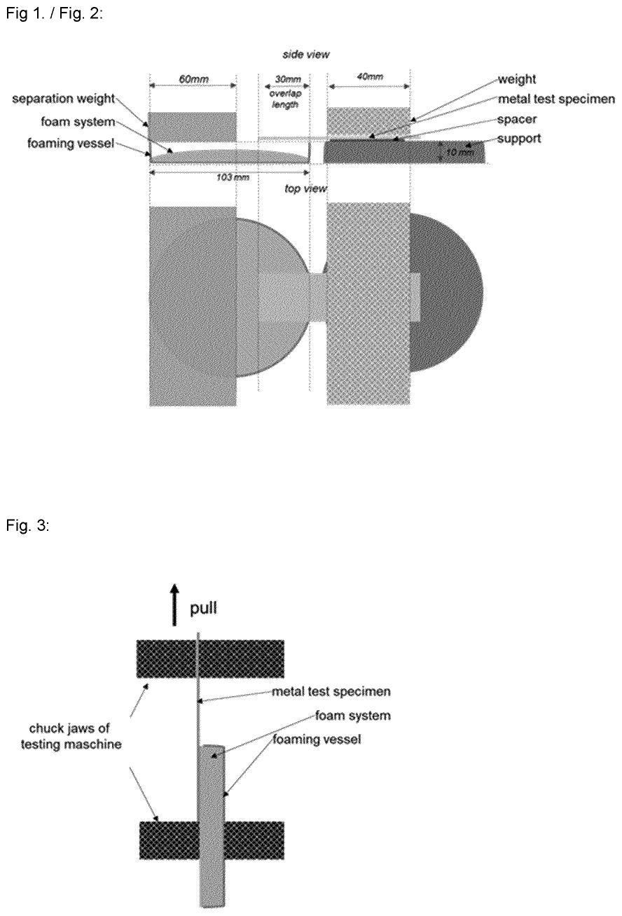

For the test on the adhesion of foam systems to metal surfaces, the metal test specimens were completely wetted on one side from below with the foaming foam system on the intended surface. In the test setup, as shown in FIG. 1 and FIG. 2, the foaming vessel was positioned on a flat surface with the opening facing upwards and a separating weight was placed from the edge to the center of the foaming vessel. The metal test specimen was placed on the support with spacer and locked with the weight. The free end of the metal test specimen was positioned with an overlap length of 3.0 cm above the foaming vessel.

### Production of the Sample

The foam system was freshly prepared in a beaker by providing the polyol component and adding the isocyanate component and then mixing with a Vollrath stirrer for 10 sec and at 1920 rpm. 23 g of the fresh foam system was then poured into the foaming vessel. The foaming vessel with fresh foam system was provided with the separation weight and the metal test piece was placed in position above the foaming vessel with an overlap length to the foaming vessel of 30 mm. The fresh foam system began to rise and completely wetted the metal test specimen from below. The excess foam system rose up the side of the metal test specimen, but without wetting the metal test specimen from above. After the foaming system had cured, the separating weight was removed and the composite of foaming vessel, foam system and adhering metal test specimen was stored in the climate at 20 °C and 50% relative humidity for 2 days and then tested in the tensile test.

### Tensile Test of the Foam System and Metal Test Specimens

The tensile test was performed according to FIG. 3. The composite of foaming vessel, foam system and adhering metal test specimen was clamped vertically into a traction machine. With a pre-force of 1N and a tensile speed of 20 mm/min, the metal test specimen was then sheared from the foam system at a 180° angle. The occurring forces were detected by means of a load cell. The maximum force of the tensile test was noted and the mean value from three repeat tests was calculated for evaluation.

### Setup of the Cup Foam Test

The cup foam test of mixed polyol and isocyanate component is done at ambient temperature. Before use the polyol component is homogenized. In total 260 g of polyol and isocyanate mixture is added into the 1290 ml-PP Cup in the sequence of polyol followed by the isocyanate component. The stopwatch is started, and the composition is mixed at 1920 rpm for 10 sec. The reaction mixture is poured into a foaming beaker with a volume of 860 ml. After 10 min the rised foam outside the beaker is cut with the knife without removing the upper part. After additional 10 minutes the upper part of the cup foam is removed to see if the foam core turned brownish.

TABLE 1

| | C1 | C2 | C3 | C4 | C5 | C6 | C7 | C8 |
|---|---|---|---|---|---|---|---|---|
| Polyol 1 | 10 | 10 | 10 | 10 | 10 | 10 | 10 | 10 |
| Polyol 2 | 40 | 40 | 40 | 40 | 40 | 40 | 40 | 40 |
| Polyol 3 | 2 | 2 | 2 | 2 | 2 | 2 | 2 | 2 |
| Cross-linker1 | 3 | 3 | 3 | 3 | 3 | 3 | 3 | 3 |
| Cross-linker2 | 2.5 | 2.5 | 2.5 | 2.5 | 2.5 | 2.5 | 2.5 | 2.5 |
| Additive 1 | 0.5 | 0.5 | 0.5 | 0.5 | 0.5 | 0.5 | 0.5 | 0.5 |
| Additive 2 | 1 | 1 | 1 | 1 | 1 | 1 | 1 | 1 |
| Additive 3 | 0.95 | 0.95 | 0.95 | 0.95 | 0.95 | 0.95 | 0.95 | 0.95 |
| Additive 4 | 3 | 3 | 3 | 3 | 3 | 3 | 3 | 3 |
| Additive 5 | 3.77 | 3.77 | 3.77 | 3.77 | 3.77 | 3.77 | 3.77 | 3.77 |
| Catalyst 1 | 0.08 | 0.08 | 0.08 | 0.08 | 0.08 | 0.08 | 0.08 | 0.08 |
| FR | 32 | 31 | 29 | 22 | 20 | 22 | 22 | 22 |
| water | 1.2 | 1.2 | 1.2 | 1.2 | 1.2 | 1.2 | 1.2 | 1.2 |
| Chain- | | 1 | 3 | 10 | 8 | 10 | | |
| extender1 | | | | | | | | |
| Chain- | | | | | 4 | | | |
| extender 2 | | | | | | | | |
| Chain- | | | | | | | 10 | 10 |
| extender 3 | | | | | | | | |
| Sum | 100 | 100 | 100 | 100 | 100 | 100 | 100 | 100 |
| Iso | 60 | 63.9 | 71.7 | 99.0 | 100.3 | 114.8 | 86.8 | 100.7 |
| Index | 90.5 | 90.5 | 90.5 | 90.5 | 90.5 | 105 | 90.5 | 105 |
| Adhesion [N] | 73 | 91 | 142 | 161 | 143 | 176 | 238 | 178 |
| FR content in | 20.0 | 18.9 | 16.9 | 11.1 | 10.0 | 10.2 | 7.7 | 7.3 |
| the foam | | | | | | | | |
| Content of | 37.5 | 38.9 | 41.8 | 49.7 | 50.1 | 53.4 | 65.1 | 66.7 |
| MDI in the | | | | | | | | |
| foam | | | | | | | | |

Formulation C1 was a polyurethane foam that was disclosed in the state-of-the-art literature and can be used for the encapsulation of electric cells (comparable to EP3753056B1 sample 1). The adhesion on Hilumin® substrates according to the described test method shows a low value of 73 N. The formulation C2 contains 1 weight percent of a chain extender inside the polyol component. This directly results in an increased adhesion on Hilumin® as the value of 91 N indi-cates. For the cases of higher amounts of chain-extenders inside the polyol component (formulations, C3, C4 and C5) the values out of the adhesion tests are even higher and all are almost twice as high as the value of C1. Example C5 contains a mixture of two chain-extenders and even for this case the adhesion test result was much higher when compared to the result of C1. Therefore, it is shown that a formulation containing a least one chain-extender has an improved adhesion to Hilumin® substrates which is desired for potting of electric cells.

C6 has the same polyol and isocyanate component as C4. The difference between C6 and C4 is the index. C4 has an index of 90.5 and C6 has an index of 100.5. This means that in the content of isocyanate is higher. Both examples show that the effect of the chain-extender to improve the adhesion on Hilumin® substrates is valid for indexes below and above 100 as the values out of the adhesion tests for C4 and C6 are more than twice as high compared to the one of C1.

The same was proved with the formulations C7 and C8 where a different chain-extender is used. The polyol component of C7 contains 10 parts of a chain-extender. C7 was prepared with an index of 90.5 and the corresponding adhesion result is more than three times higher in com-parison to the one of C1. By using the same polyol component but increasing the index which was the case for example C8 the value out of the adhesion test is still on a very high level.

TABLE 2

| | C1 | C9 | E1 | E2 | C10 |
|---|---|---|---|---|---|
| Polyol 1 | 10 | 10 | 10 | 10 | 10 |
| Polyol 2 | 40 | 40 | 40 | 35 | 30 |
| Polyol 3 | 2 | 2 | 2 | | |
| Polyol 4 | | | | 2 | 2 |
| Cross-linker1 | 3 | 3 | 3 | 3 | 3 |
| Cross-linker2 | 2.5 | 2.5 | 2.5 | 2.5 | 2.5 |
| Additive 1 | 0.5 | 0.5 | 0.5 | 0.5 | 0.5 |
| Additive 2 | 1 | 1 | 1 | 1 | 1 |
| Additive 3 | 0.95 | 0.95 | 0.95 | 0.95 | 0.95 |
| Additive 4 | 3 | 3 | 3 | 3 | 3 |
| Additive 5 | 3.77 | 3.77 | 3.77 | 3.77 | 3.77 |
| Catalyst 1 | 0.08 | 0.08 | 0.08 | 0.08 | 0.08 |
| FR | 32 | 27 | 22 | 16 | 6 |
| water | 1.2 | 1.2 | 1.2 | 1.2 | 1.2 |
| Chain-extender1 | | | | | |
| Chain-extender 2 | | | | | |
| Chain-extender 3 | | | 9 | | |
| Chain-extender 4 | | 5 | 1 | 1 | 1 |
| Chain-extender 5 | | | | 20 | 35 |
| Sum | 100 | 100 | 100 | 100 | 100 |
| Iso | 60 | 66.7 | 85.4 | 94.4 | 119.2 |
| Index | 90.5 | 90.5 | 90.5 | 90 | 90 |
| Adhesion [N] | 73 | Not | 266 | Not | Not |
| | | possible | | measured | measured |
| FR content in | 20.0 | 16.1 | 11.9 | 8.2 | 2.7 |
| the foam | | | | | |
| Content of MDI | 37.5 | 40.0 | 46.1 | 48.6 | 54.4 |
| in the foam | | | | | |

C9 is an example with 5 parts of an aromatic diamine as chain-extender. With this formulation it was observed that after mixing it with the isocyanate component the viscosity increased too fast and it was not possible to perform the adhesion test with this formulation. By lowering the amount of the diamine and combining it with an OH-terminated chain-extender (E1) it was possible to perform the test and a very high adhesion value which is more than three times higher as the one from example C1 was measured. E1 shows that the combination of an OH-terminated chain-extender with a low amount (<5 parts) of an aromatic diamine is capable to improve the adhesion on Hilumin® substrates.

In E2 and C10 higher amounts of chain extender are applied. While in E2 with a chain extender concentration of 11.4 parts by weight, based on components a) to (f), still a suitable foam with white core was obtained, for C10 with a chain extender concentration of 17.2 parts by weight, based on components a) to (f) shows a brownish core indicating high center temperatures of the foam indicating a high temperature during foam formation. A temperature measurement within the foam shows after 5 minutes reaction time an about 20 °C lower core temperature in E2 compared to the foam according to C10. This high temperature is likely to damage electric cells during potting.

1. A battery module, comprising electric cells potted into a potting material, wherein the potting material is obtained by mixing:
a) one or more organic polyisocyanates,
b) one or more polymeric compounds having at least two isocyanate-reactive hydrogen atoms
c) 0.5 to 15 wt. %, based on the total weight of components a) to f), of chain extenders, comprising O—H-chain extenders (c1) and aromatic diamine curing agents (c2),
d) optionally one or more cross linkers
e) one or more catalysts,
f) 2 to 20 wt. % based on the total weight of components a) to f), of one or more flame retardants,
g) at least one blowing agent and
h) optionally fillers and/or polyurethane additives,
to give a reaction mixture and allowing the reaction mixture to cure.

2. The battery module according to claim 1 wherein the one or more polymeric compounds having at least two isocyanate-reactive hydrogen atoms (b) comprise a polyetherol (b1) having a functionality of 2 to 4 and a hydroxyl value of 20 to 60 mg KOH/g.

3. The battery module according to claim 2, wherein the polyetherol (b1) comprises at least 80% of primary hydroxyl groups.

4. The battery module according to claim 1, wherein the organic polyisocyanates (a) comprise at least one Isocyanate selected from the group consisting of monomeric MDI, polymeric MDI, MDI based prepolymers and mixtures of at least two of these.

5. The battery module according to claim 1 , wherein an isocyanate index is from 80 to 120.

6. The battery module according to claim 1, wherein a content of monomeric MDI and polymeric MDI in component (a), including monomeric and polymeric MDI (a-1) which was used for the production of polyisocyanate prepolymers, is at least 35% by weight, based on a total weight of components (a) to (f).

7. The battery module according to claim 1, wherein the OH-chain extender (c1) is selected from the group consisting of monoethylene glycol, diethylene glycol, dipropylene glycol, 1,2-propane diol, 1,3 propane diol, 1,4 butane diol, 1,6 hexane diol and mixtures thereof.

8. The battery module according to claim 1, comprising 0.5 to 4% by weight of at least one aromatic diamine curing agent (c2).

9. The battery module according to claim 8 wherein the mass ratio between the OH-chain extender (c1) and the aromatic diamine curing agent (c2) is between 200 to 1 and 1 to 1.

10. The battery module according to claim 1, wherein the flame retardant comprises liquid flame retardant.

11. The battery module according to claim 1, wherein the flame retardant comprises phosphorous based flame retardant and the content of phosphorus, based on a total weight of the components (a) to (f), is 0.1 to 1% by weight.

12. The battery module according to claim 1, wherein the blowing agent comprises water.

13. The battery module according to claim 1, wherein a density of the potting material is between 50 and 600 g/dm³.

14. The battery module according to claim 1, wherein component b) comprises polymer polyol.

15. The battery module according to claim 14, wherein a content of polymer polyol based on a total weight of compounds (a) to (f) is between 2 and 30% by weight.

16. The battery module according to claim 1, wherein component (e) comprises a delayed action catalyst.

17. A method of producing a battery module comprising;
providing a battery case having electric cells arranged within defining spaces between adjacent electric cells,
obtaining a reaction mixture obtained by mixing:
a) one or more organic polyisocyanates,
b) one or more polymeric compounds having at least two isocyanate-reactive hydrogen atoms c) 0.5 to 15 wt.-%, based on the total weight of components (a) to (f), of chain extenders, comprising O—H-chain extenders (c1) and aromatic diamine curing agents (c2)
d) optionally one or more cross linkers
e) one or more catalysts,
f) 2 to 20 wt.-% based on the total weight of components a) to f), of one or more flame retardants,
g) at least one blowing agent and
h) optionally fillers and/or polyurethane additives and
inserting the reaction mixture into the spaces between the adjacent electric cells and
allowing the reaction mixture to cure.
